(19) United States
(12) Patent Application Publication
(10) Pub. No.: US 2008/0169748 A1
(43) Pub. Date: Jul. 17, 2008

(54) Flat Panel Displays Arrangement

(76) Inventor: Vitor Renaux Hering, Soa Paulo (BR)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/569,086

(22) PCT Filed: May 13, 2005
(86) PCT No.: PCT/BR05/00081

§ 371 Date: Mar. 27, 2008

(30) Foreign Application Priority Data
May 14, 2004 (BR) PI0402052-9

(51) Int. Cl. H01J 1/62

(52) U.S. Cl. 313/496

(57) ABSTRACT

FLAT PANEL DISPLAYS ARRANGEMENT comprising a first subset for electron emission and control (10) in the form of a rigid substantially plane block, to whose anterior face is juxtaposed a second screen subset (20) formed by a rigid transparent layer (21), provided with a conductive coating that forms the anode (22), and with a plurality of regions coated with luminescent phosphor (26), as well as a closing subset (30) constituted by a rigid plate (24) facing the opposed face of said first subset (10), having the surface turned to this subset overlaid with a uniform coating (25) of material with the property of gas absorption (getter). Said block (10) is formed by juxtaposing a dielectric layer (11), a first conductive layer (13), a second dielectric layer (14) thinner than the first dielectric layer and a second conductive layer (15), thinner than the first conductive layer, said block being traversed by a plurality of prismatic through-holes (17), in the interior of which vacuum is provided, the form and dimensions of the hole's transversal section being substantially equal to the regions (26) coated with luminescent phosphor.

### FIELD OF INVENTION

The present invention is related to elements of electron emission used in flat panel displays.

### DESCRIPTION OF THE PRIOR ART

In the last years considerable efforts have been made in the development of feasible flat panel displays. There are many competing technologies, such as liquid crystals, plasma, electro luminescent phosphor and field emission.

The field emitters, better known as Field Emission Displays—FEDs, were originally built using the tip effect, as described by C. A Spindt (A Thin-Film Field Emission Cathode, Journal of Applied Physics, Vol. 39, No. 7, June 1968). In these devices, electron emission is provided by a plurality of electrodes with sharp tips, what results in a localized concentration of electric field and subsequent cold electron emission by tunneling through the surface potential barrier. This barrier constitutes the so called material's “work function” and its value depends not only on the material itself but on the surface conditions. Besides these emitters, the known devices comprise a transparent anode covered with phosphor on its inside face and an accelerating grid interposed between the anode and said electrodes, being doser to them.

In these devices, the electrons are emitted when a negative tension is applied to said emitters and a positive tension to said grid, being the electron flow controlled by the tension value applied to the grid in relation to said emitters. The anode is positively polarized with a tension of greater value than the one applied to the grid, being the ensemble hermetically closed in order to form a chamber whose interior is vacuum.

One of the first examples of such devices is found in the patent U.S. Pat. No. 3,665,241 (Field Ionizer and Field Emission Cathode Structure and Methods of Production) having as inventors L. N. Heynick and C. A. Spindt, dated 1972. The described structure consists of a plurality of sharp emitters, pyramidal or conic, superposed on a conductive substrate, complemented by an accelerating grid electrically isolated from the referred emitters and provided with apertures having their centers coincident with the referred Spindt emitters tips.

A more elaborated example of such device is described in the patent U.S. Pat. No. 5,763,998 (Field Emission Display Arrangement with Improved Vacuum Control) whose inventors are P. Colombo, J. E. Tolan and K. J. Hubbard. According to this document, a severe problem that affects this kind of device derives from the vacuum contamination by residual gases molecules that detach from the surfaces of the many utilized materials. These molecules may be ionized not only by the electric field applied to the FED elements but also by collision between electrons with the molecules. Said ions are attracted by the electrically polarized surfaces destructively hitting them with subsequent emission structures degradation. Even in the absence of ionization, the simple absorption of the molecules by the emitters surface alters their work function. Occasional localized detachment of significant gas volumes implies in the increase of the quantity of ionized molecules, which also facilitates the appearance of destructive electric discharges between the Spindt emitters and the grid, making the device useless.

In order to keep appropriate vacuum conditions, molecules must be removed from the region where electrons are passing. This is achieved by positioning inside the chamber a substance that captures contaminant gas molecules, being this substance called getter. The fact that the molecules ionized by the interaction with the electron beam are attracted by the electrically biased surfaces contributes to the pumping process, in the way that the ions acquire enough energy to be sub-implanted in the surfaces, resulting in the capturing of the residual gases and subsequent pressure reduction. At the same time, this very process of capturing is also responsible for the alteration of the emission surfaces, causing their destruction. In accordance to the patent U.S. Pat. No. 5,763,998, it is of fundamental importance to the display chamber to present high vacuum conductance, therefore resulting in fast removal of the molecules by the getter, reducing the possibility of collision and subsequent ionization of the molecules. The first panels of this kind presented conduits in their margins, which contained the referred getter, demanding the dislocation of molecules by gaseous diffusion in parallel to the extension of the panel until reaching the getter where they were retained. Such process of dislocation was named “longitudinal pumping” and only revealed satisfactory results in panels of reduced dimensions, where the molecule's path is sufficiently short (in relation to the distance between the anode and the cathode) so that the number of interactions between the molecules and the walls, before the capture by the getter, is substantially reduced, avoiding, as much as possible, damages to the electron emission elements. In panels of large dimensions, the greater distance between the marginal conduits and the center of the screen renders such constructive method ineffective, once it would oblige the distances between anode and cathode not to match the concept of thin panel.

The resolution of pixels (image elements), specially for color panels, depends on electron beams properly focused, once the defocusing of the beam would result in part of the electrons, destined to a particular color, hitting the neighbor elements corresponding to the other colors. This defocusing is related to many factors, being the distance traveled by the electrons between the emission element and the image element one of the most important, that is the image element as the phosphor layer juxtaposed to the anode plate. In the panels built in accordance to the prior art, the typical distance between the emission structure and the anode plate is of 1 millimeter in order to guarantee minimal satisfactory pumping conditions, what requires the use of spacers oh high aspect ratio, which are of difficult implementation. Moreover, dielectric spacers present the downside of building an electric charge during the use of the panel due to the impact of some electrons that scatter from a not sufficiently focused beam. This effect causes a poor image quality, such as the appearance of shadows in the image coinciding with said spacers, what requires the use of additional elements to control the scattering of electron beams. As described in the patent U.S. Pat. No. 6,013,974 said elements, made by focusing grids aimed to reduce the spreading of the beam, are of difficult implementation, requiring costly and complex manufacturing techniques.

Another way to avoid the referred charging consists in manufacturing spacers with high resistance conducting materials. The referred conductivity enables the electrons to flow through the spacer towards the conductive surface to what the said spacers are in contact. Once said spacers are inserted between the conductive surfaces of the anode and the control grid, a draining current will build up, which will eliminate the downsides associated to dielectric spacers. However, the existence of such a current presents a consumption of energy that must be supplied by the device's power source.

Another proposed structure, described in the Brazilian patent PI 0001211-4, presents the innovation of making a uniform getter distribution along the interior surface of the screen, improving the vacuum conductance without the necessity of complex and expensive structures. The referred invention innovates the construction of a screen by uniformly distributing micro-pores along the panel surface. These micro-pores have the function of putting in contact the two vacuum chambers posterior and anterior, enabling that occasional ions present in the anterior chamber, the one traversed by the electrons, be better absorbed by the getter distributed along all the surface of the posterior chamber. The same invention also innovates in substituting the sharp structures of “Spindt emitters” by metallized holes presenting sharp edges that operate as efficient electron emitting cathodes. Such structure embodiment, in spite of being more efficient and less costly in relation to the former models, still presents a large number of complexities that contribute to complicate and to render costly its mass production. In this manner, for example, the spacers positioned in the anterior chamber in order to keep the distance between the emitting structure and the image screen, must be built with precise dimensions, reduced transversal section and exact positioning in order to avoid deflections of the emission membrane and occasional shadows in the image.

### OBJECTIVES OF THE INVENTION

In accordance to what was previously explained, the present invention has the objective of presenting a new type of field emission screen whose production method results in a more efficient and more compact structure with higher rigidity and mechanical resistance and more simple and cost effective as far as its production is concerned.

Another objective is to avoid the use of spacers with critical dimensions.

Yet another objective is to provide a screen that associates properties of robustness, reliability and durability.

### BRIEF DESCRIPTION OF THE INVENTION

The aforementioned objectives are attained by this invention by providing a display comprising a first subset of emission and control of electrons, said subset consisting of a substantially plane block delimited by an anterior region and a posterior region, formed by the juxtaposition of:
a first dielectric layer having a first and second faces;
a first conductive layer juxtaposed to the said second face of the dielectric layer;
a second dielectric layer comprising a third and forth faces, said third face juxtaposed to the said first conductive layer;
a second conductive layer juxtaposed to the said forth face of the second dielectric layer, being the referred block crossed by a plurality of prismatic traversing holes, having a first and second bases coinciding, respectively, with the first face of the first dielectric layer and with the external face of the said second conductive layer.

In accordance to another feature of this invention, the referred display further comprises the screen subset, situated in the said anterior region, which comprises a first rigid and transparent layer, coated by a conductive layer, transparent or not, depending on the application and on the structure, which forms the anode that collects the electrons emitted by the structure described above, being said anode turned to the said first face of the first dielectric layer.

In accordance to another feature of this invention, the referred screen set further comprises regions coated with a substance (“phosphor”) that produces light when hit by electrons.

According to yet another feature of this invention, the said first conductive layer is polarized with a positive potential in relation to the second conductive layer working as a control grid, where said second conductive layer assumes the function of cathode in the referred device. The conductive layer that forms the anode is polarized with a positive potential substantially greater than the potential of the control grid.

In accordance with another feature of this invention, said first base of the prismatic holes is enclosed by the juxtaposition of said screen with the first face of the first dielectric layer.

According to another feature of the invention, the display comprises, in the posterior region, a closing subset formed by a rigid plate facing the said second conductive layer, being the surface turned to it covered with material having the quality of gas absorption (getter), which enables the maintenance of high vacuum in the interior of the display.

In accordance with yet another feature of the invention, said rigid plate is positioned to enclose said second base of the prismatic holes.

In accordance with one more feature of the invention, said prismatic holes are filled with a solid substance that enables the free transit of electrons, substituting the vacuum.

According to one more feature of the invention, said substance that fills the holes is the DLC or an equivalent.

### BRIEF DESCRIPTION OF THE DRAWINGS

The overall features and advantages of this invention shall be better understood through the description of the preferred embodiments, given as examples and not in a sense of limitation, and through the drawings of which:

FIG. 1 shows, through a section of a perspective view, the structure of electron emission and control, referring to a single hole, in accordance with principles of this invention.

FIG. 2 shows, through a orthogonal section referring to a single hole, a first embodiment of the display, in accordance to the principles of this invention.

FIG. 3 shows, through a orthogonal section referring to a single hole, the provisioning of nanostructured material for electron emission, in accordance to the principles of this invention.

FIG. 4 shows, through a orthogonal section referred to a single hole, a second embodiment of the invention.

FIG. 5 shows, through a similar orthogonal section, a third embodiment of the invention.

### DETAILED DESCRIPTION OF THE INVENTION

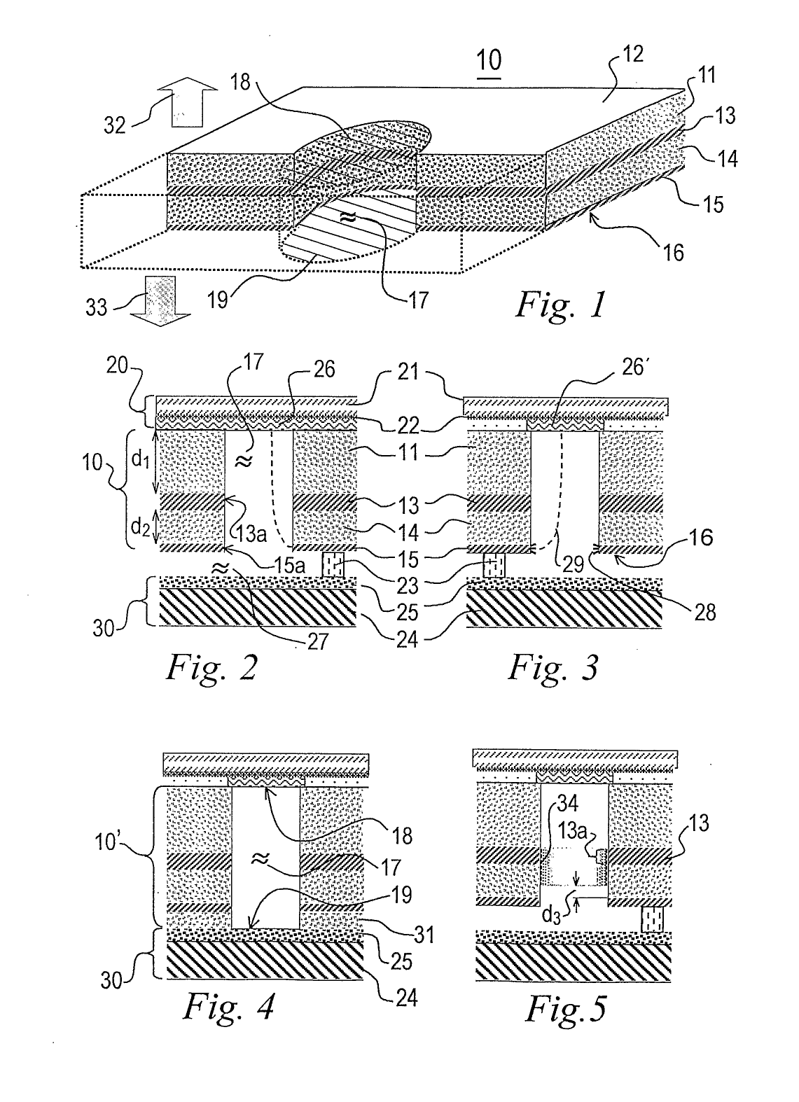

According to FIG. 1, the structure of electron emission and control 10 comprises a first dielectric layer 11 with a first face 12 turned to the anterior region 32 of the display, a second face not shown in the figure, as well as a second dielectric layer 14, being a first conductive layer 13 inserted between both. The opposed face of said second dielectric layer is covered by a second conductive layer 15 whose external face 16 is turned to the posterior region 33 of the display, forming, therefore, the illustrated subset a multilayer structure, through which is provided the trespassing prismatic hole 17, in the present case in the form of a right cylinder having its first base 18, turned to the said first anterior region 32, in the plane of the said first face 12 and its second base 19, turned to the said posterior region, in the plane of external face 16 of the said second layer 15.

Through a transversal cut FIG. 2 illustrates the structure of the display, in which is observed the screen subset 20 juxtaposed to the face 12 (not referred in this figure) of the first dielectric layer 11, in the way to enclose the superior base 18 (not referred in this figure) of the hollow prism 17. Said screen subset 20 comprises a transparent rigid plate 21, having its internal face covered with the conductive layer of the anode 22 over which is deposited light emitting material (“phosphor”) 26 forming an image element (“pixel”). In the present exemplifying concretization said material has approximately the same form and dimension of the transversal section of the prism 17, that is, of its first base 18.

FIG. 2 also shows the closing subset 30 in the posterior region of the display, the space between the external face 16 of the second conductive layer and said closing set forming a posterior vacuum chamber 27 that communicates with said hollow prism through the inferior base 19. The distance between said dosing set 30 and the subset 10 is provided by the spacers 23, of which transversal dimensions, as well as its positioning, are not critic, once they are not situated in the region of the display associated with the production of image, in the way that happens, for example, with the spacers situated in the anterior chamber of the known displays, like the ones described in the documents U.S. Pat. No. 6,013,974 and PI 0001211-4. The distance between said spacers permits the free circulation of gases through the chamber.

In the arrangement of the present invention, the closing subset 30 is constituted by the rigid plate 24 covered, in the face turned to the posterior chamber 27, by a uniform layer of getter 25, material that retains the molecules of contaminant gas. This arrangement provides high vacuum conductance, in the way to result in the fast removal of residual gas molecules in the interior of the prisms 17, keeping the necessary vacuum quality that asserts reliability and durability to the device.

In accordance with the principles of the invention and according to the FIGS. 1 and 2, the device is operated by means of the application of a first positive tension V+ to the first conductive layer 13 and a second positive tension V++, with a higher value than the one of the said first positive tension, to the anode 22, taking as a reference the tension of the second conductive layer 15. Due to the proximity between the exposed surface 13a of the first layer and the border 15a of the second layer, there is a potential gradient between said elements, which is enough to produce cold electron emission from the said border 15a, which works as cathode. Once in the free space in the interior of the prism 17 the electron is accelerated by the tension V++ of the anode, describing approximately the path indicated in the figure by the interrupted line When it hits the anode 22, the kinetic energy of the electrons that incise in the phosphor coating 26 is transformed in luminous radiation, whose intensity depends on the accelerating tension V++ as well as on the quantity of electrons, which, by its turn, is a function of the tension V+ between the second conductive layer 15 and the first conductive layer 13, exerting the portion 13a of this last the function of control grid. The value of some kilovolts of the tension V++ produces an acceleration with enough high value to result in an efficient process of light emission. Nevertheless the figure shows the anode 22 situated between the phosphor coating 26 and the rigid transparent plate 21, the efficiency of the luminous emission could be further improved by depositing the phosphor directly over the internal face of the rigid transparent plate 21, being the conductive coating of the anode applied over the exposed phosphor face, in the way that what is done in the cathodic ray tubes utilized as TV receptors. In this case, the conductive coating is made of material reflexive for electrons, for example, aluminum, enabling to take advantage of the luminosity emitted in the direction of the interior of the prism 17, which is in this way reflected in the direction of the rigid transparent plate 21.

The arrangement illustrated in FIG. 2 presents, among others, the advantage of avoiding focusing problems, since the electrons have trajectories confined to the interior of the hollow prism 17, incising only in the phosphor coating 26 correspondent to the transversal section of said prism. Consequently, there is not the problem of primary color contamination due to dispersion of the electron beam that results in the luminescence of adjacent phosphor regions, of different primary colors, as it occurs in known devices. Another advantage of the structure illustrated in FIG. 2 resides in the grater robustness of the display, since the rigid subset 20 is solidary with the subset 10 forming a rigid set.

In accordance with the invention, the display comprises a plurality of prismatic holes regularly distributed, associated to the three primary colors by means of the adequate choice for the phosphor dots 26. The selective excitation of pixels (image elements) is obtained through the matriciation of cathodes and control grids, being the conductive layers 13 and 15 in the form of tracks parallel and isolated of each other, forming two sets of tracks angularly disposed, being said tracks excited individually in order to enable the selection of the pixel situated in the crossing of a determined track 13 with a determined track 15. In a preferred embodiment of the invention, said tracks are disposed in a substantially orthogonal way.

In spite of FIG. 1 showing trespassing holes 17 with cylindrical form, another prismatic configurations—right or oblique—may be utilized, like ovals or polygons convex or not, these last comprising the ones that contain two points where the line segment that unit these points contains elements that do not belong to the set of points contained inside the referred closed polygon, as it happens, for example, with the starry polygons.

In a preferred embodiment, the thickness of said second conductive layer 15 (which forms the cathode) is substantially inferior than the first conductive layer 13 (which forms the control grid), the same occurring with the thickness d2 of said second dielectric layer 14, substantially smaller than the thickness d1 of the first dielectric layer 11. The smaller thickness of said layer 14 enables obtaining elevated potential gradients with relative reduced values of tension V+, what makes the implementation of control circuits utilized in the matriciation less critic.

FIG. 3 essentially shows a cut view similar to FIG. 2 with the particularity of being the cathode border 15a covered with a material 28 with low effective work function, this way designated by the fact of facilitating the electron emission. Such material may be a carbet of refractory material, a Boron compound, or a nanostructured material, which is made by structures having dimensions in the order of nanometers as, for example, carbon nanotubes. Such material may be applied through a variety of processes, comprising, for example, nanostructured material obtained by electrolytic process. In this figure is also observed, that the phosphor is applied in a region 26′ with approximately the same dimensions of the transversal section of said prism. This arrangement is particularly adequate for color displays, since it makes inexistent the problem of primary color contamination due to electron beam dispersion what would result in the luminescence of adjacent phosphor regions, of different primary colors, as it occurs in the known devices.

FIG. 4 illustrates an alternative concretization of the invention where the posterior vacuum chamber 27, shown in the FIGS. 2 and 3, was eliminated via the juxtaposing of the enclosing subset 30 to the emission and control subset 10′, modified with the increment of one more layer of isolating material 31 with a convenient thickness. The utilization of said isolating layer renders necessary once being the getter a conductive material, usually a metal. In this device the vacuum is restricted only to the interior of the prismatic holes 17, which will be individually sealed, in the way to limit to a single pixel the occasional image problems caused, for example, by localized heating.

The structure proposed for the emission and control subset 20 enables its production through processes substantially simpler than the ones applied for the obtainment of the known devices. These processes may be implemented through the method described hereunder.

Initially, the first dielectric layer 11 is coated with a conductive layer 13, such as, for example, a metal, which is engraved in order to provide the parallel tracks that will enable the matriciation of pixels. The application of such layer may be done through any known process, such as thermal evaporation, sputtering, galvanoplastic deposition, or lamination, i.e., the simple juxtaposition of a metallic layer and its union to the dielectric via an adhesive under the appliance of pressure and temperature, as it is done for the press circuit plates. The dielectric material may be polyimide, plastic, kapton, Teflon, boron nitrite, ceramic, glass, etc. and its thickness shall be enough to provide the necessary mechanical rigidity. The confection of the tracks in the first conductive layer 13 is made through known processes, comprising, among others, lithographic engraving, lift-off, milling, etc. In an alternative form, the tracks may be deposited through masks, avoiding the necessity of removal of the material inherent to the processes of engraving.

A second dielectric layer 14 is then deposited over the layer 13, through known techniques such as spin-on, spray, CVD, sol-gel, lamination, etc. having substantially less thickness than the first dielectric layer 11. A second conductive layer 15, which will form the cathodes, is deposited and over said second dielectric layer through a similar process than the one used on the first conductive layer, being the tracks formed and configured through known processes, said tracks forming an angle with the tracks of the conductive layer 13, the tracks of both said layers may be or not substantially perpendicular among each other. All the layers are solidary among them, in order to form a single block.

In the following, trespassing prismatic holes are opened through the referred block, in the way to let exposed, in the walls of each prism, the border 15a that takes the roll of cathode and the belt 13a that works as control grid. The process of opening the holes may be performed by means of mechanical stamping, perforation by means of drills, engraving, laser radiation, plasma etching, among others. Alternative fabrication processes comprehend: sinterization, extrusion, molding, etc.

After the referred perforation, the subset 10 is enclosed between the screen subset 20 to which it is juxtaposed, being or not laminated to this last, and the screen subset 30 which is separated by the spacers 23, being the whole set sealed through the appliance of heat along the borders may being this process realized under high vacuum conditions or under ambient atmosphere followed by evacuation.

In accordance to the same characteristics, the above exposed is not by any means an impeditive way of utilizing other fabrication techniques of said holes, being only one of the possible ways of concretization. Other ways of accomplishing are also contemplated by the present invention, such as, for example, the electrochemical deposition of conductive and insulating materials over an appropriate substrate, formatting the holes structure by means of appropriate masks.

According to another way of realization of the invention, the metallic surface of the cathode 15a may be coated with material with low effective work function, to facilitate electron emission, thus contributing to optimize de performance of the device and enabling to reduce even more the tension V+ applied between control grid and cathode. Said coating may be obtained through simple application of nanostructured material 28 by contact, through electrochemical deposition or through nanostructure formation by means of chemical reactions in liquid media or solid-gas reactions, involving these two last processes the masking or not of the grid 13a. Once being preferentially metallic the layers 13, 15 of the grid and the cathode, the mask material should be inert to the chemical reactions involved in the reactions for formation of materials of low effective work function over the cathode 15a. An inert material particularly adequate for masking the grid is the nickel electrodeposited over the exposed surface 13a. FIG. 5 illustrates the said tubular mask 34, which may be prolonged to over the belt 13a, along the hole wall towards the cathode however without touching it, obtaining by this way a reduced distance d₃ between cathode and control grid, what enables the use of lower cathode-grid tension values for electron emission, providing better control for the beam commutation. Likewise, the referred mask 34 increases the effective dimension of the grid in the axial direction, what results in a better electron beam focusing though reducing the incidence of these on the hole borders.

Even being the invention described in terms of exemplifying embodiments, modifications and variations are possible among the scope of the inventive idea. By this way, for example, the interior of the prismatic hole 17 may be filled with a solid material that permits the free traffic of electrons, thus avoiding the necessity of providing vacuum in the device. This material may be, for example, the DLC or equivalent.

In accordance, the invention is described in the claim set that follows.

1. “FLAT PANEL DISPLAYS ARRANGEMENT” characterized by comprising a first subset for electron emission and control (10) consisting of a substantially plane block delimitated by an anterior region (32) and a posterior region (33) of the display, a second screen subset (20) situated in the said anterior region, characterized by the fact of said first subset (10) be formed by the juxtaposing of:
A first dielectric layer (11) with a first (12) and a second faces;
A first conductive layer (13) juxtaposed to said second face of the dielectric layer;
A second dielectric layer (14) comprehending a third and a forth faces, said third face juxtaposed to said first conductive layer,
A second conductive layer (15) juxtaposed to said forth face of the second dielectric layer,
Being the referred block (10) crossed by a plurality of trespassing prismatic holes (17), presenting a first (18) and a second (19) coincident bases, respectively, with the said first face (12) of the first dielectric layer and with the external face (16) of the said second conductive layer.

2. “FLAT PANEL DISPLAYS ARRANGEMENT” in accordance with claim 1, characterized by the fact of comprising the screen subset (20), situated in the anterior region (32), comprehending a first rigid and transparent layer (21), provided with a conductive layer that forms the anode (22), being this facing the said subset of electron emission and control (10) and by being the opening of said first base (18) of said trespassing prismatic holes (17) enclosed by means of juxtaposing said screen subset (20) to de first face (12) of said subset of electron emission and control (10).

3. “FLAT PANEL DISPLAYS ARRANGEMENT” in accordance with claim 1, characterized by the fact that said screen subset (20) is laminated to the said first face (12) of said subset of electron emission and control (10).

4. “FLAT PANEL DISPLAYS ARRANGEMENT” in accordance with claim 2, characterized by the fact of said screen subset (20) additionally having a phosphor coating (26).

5. “FLAT PANEL DISPLAYS ARRANGEMENT” in accordance with claim 2, characterized by the fact that said screen subset (20) additionally has a plurality of regions or dots (26′) covered with a coating of phosphor substantially coinciding substantially each said region, in position and dimension, with the first base (18) of each said prismatic holes (17).

6. “FLAT PANEL DISPLAYS ARRANGEMENT” in accordance with claims 4 or 5, characterized by the fact of being said phosphor coating (26, 26′) applied over the exposed face of the transparent conductive layer that forms the anode (22) being this applied over the face of the rigid and transparent layer (21) turned to the subset of electron emission and control (10).

7. “FLAT PANEL DISPLAYS ARRANGEMENT” in accordance with claims 4 or 5, characterized by the fact of being said phosphor coating (26) directly applied over the face of said first rigid and transparent layer (21) turned to the subset of electron emission and control (10) being the conductive layer that forms the anode (22) constituted by reflexive material applied over the exposed face of said phosphor coating.

8. “FLAT PANEL DISPLAYS ARRANGEMENT” in accordance with claim 1, characterized by the fact of said display additionally having a closing subset (30) constituted by a rigid plate (24) facing de said second conductive layer (15), being the surface turned to this layer covered with a uniform coating (25) of material with gas absorption character (getter).

9. “FLAT PANEL DISPLAYS ARRANGEMENT” in accordance with claim 8, characterized by the fact that said subset (30) is set apart of said layer (15) by means of a plurality of spacers (23), the space between said subset and said layer forming a posterior vacuum chamber which communicates with said prismatic holes (17) through the second bases (19) of them.

10. “FLAT PANEL DISPLAYS ARRANGEMENT” in accordance with claim 8, characterized by the fact that said closing subset (30) encloses the second opening of the second base (19) of the said trespassing prismatic holes (17) by means of its juxtaposition to the first subset of electron emission and control (10′) modified by the superposition, to the external face (16) of the second conductive layer (15), of a third dielectric layer (31) which is also permeated by prismatic holes that constitute the substantial prolongation of the holes (17) that trespass the block (10) that constitutes the first subset of electron emission and control.

11. “FLAT PANEL DISPLAYS ARRANGEMENT” in accordance with claim 1, characterized by the fact that said trespassing prismatic holes (17) are straight prisms.

12. “FLAT PANEL DISPLAYS ARRANGEMENT” in accordance with claim 1, characterized by the fact of said trespassing prismatic holes (17) are oblique prisms.

13. “FLAT PANEL DISPLAYS ARRANGEMENT” in accordance with claim 1, characterized by the fact of said trespassing prismatic holes (17) have circular section.

14. “FLAT PANEL DISPLAYS ARRANGEMENT” in accordance with claims 11 or 12, characterized by the fact of said trespassing prismatic holes (17) having an oval section.

15. “FLAT PANEL DISPLAYS ARRANGEMENT” in accordance with claims 11 or 12, characterized by the fact of said trespassing prismatic holes (17) having an oblong section.

16. “FLAT PANEL DISPLAYS ARRANGEMENT” in accordance with claims 11 or 12, characterized by the fact that said trespassing prismatic holes (17) having a closed polygonal section.

17. “FLAT PANEL DISPLAYS ARRANGEMENT” in accordance with claims 11, 12 or 16, characterized by the fact that the closed contour that delimitates the section of the prismatic holes defines a closed region that contains at least two points in the way that the line segment that unites them contains points that are not contained in the interior of the referred contour.

18. “FLAT PANEL DISPLAYS ARRANGEMENT” in accordance with claim 1, characterized by the fact of being the thickness of said first dielectric layer (11) substantially thicker than the thickness of the others (14, 31)

19. “FLAT PANEL DISPLAYS ARRANGEMENT” in accordance with claim 1, characterized by the fact of being the thickness of said first conductive layer (13) substantially thicker than the thickness of the said second conductive layer (15).

20. “FLAT PANEL DISPLAYS ARRANGEMENT” in accordance with claims 1, 3, 4, 18 or 19 characterized by the fact of being the element of electron emission—cathode—constituted by the exposed border (15a) of the e nd conductive layer (15) that circles the inner wall of the trespassing prismatic hole (17) and by being the element of electron flow control—grid—constituted by the exposed border (13a) of the first conductive layer (13) that circles the said wall.

21. “FLAT PANEL DISPLAYS ARRANGEMENT” in accordance with claim 20, characterized by the fact of being said cathode (15a) coated with nanostructured material (28).

22. “FLAT PANEL DISPLAYS ARRANGEMENT” in accordance with claim 20, characterized by the fact of being said coating with nanostructured material (28) obtained by means of electrochemical processing.

23. “FLAT PANEL DISPLAYS ARRANGEMENT” in accordance with claim 21, characterized by the fact of being said coating with nanostructured material (28) obtained by means of chemical reactions in liquid media.

24. “FLAT PANEL DISPLAYS ARRANGEMENT” in accordance with claim 21, characterized by the fact of being said coating with nanostructured material (28) obtained by means of solid-gas reactions.

25. “FLAT PANEL DISPLAYS ARRANGEMENT” in accordance with claim 21, characterized by the fact of being said coating with nanostructured material (28) obtained by means of chemical vapor deposition.

26. “FLAT PANEL DISPLAYS ARRANGEMENT” in accordance with claims 20, 23, 24 or 25, characterized by the fact of being provided the masking of the grid (13a) by a layer of conductive material inert to the chemical reactions involved.

27. “FLAT PANEL DISPLAYS ARRANGEMENT” in accordance with claim 26, characterized by the fact of being said inert conductive material the elecrodeposited nickel.

28. “FLAT PANEL DISPLAYS ARRANGEMENT” in accordance with claim 26 or 27, characterized by the fact of prolonging said layer to over the grid belt (13a) along the hole wall (17) partially towards the cathode.

29. “FLAT PANEL DISPLAYS ARRANGEMENT” in accordance with claim 21, characterized by the fact of being said coating with nanostructured material constituted by carbon nanotubes.

30. “FLAT PANEL DISPLAYS ARRANGEMENT” in accordance with claim 20, characterized by the fact of being the cathode opening (15a) larger than the opening of the prismatic hole (17).

31. “FLAT PANEL DISPLAYS ARRANGEMENT” in accordance with claims 1, 2, 20 or 30, characterized by the fact of being applied to the said anode conductive layer (22) a positive tension with value (V++) substantially greater than the positive tension (V+) applied to the said first conductive layer, taking as tension reference the said second conductive layer (15).

32. “FLAT PANEL DISPLAYS ARRANGEMENT” in accordance with claims 1, 2, 20, 28, 30 or 31, characterized by the fact of movement of electrons (29) in the interior of the prismatic holes start in a direction approximately perpendicular to the longitudinal axe of said hole, the tension (V++) from de anode providing their gradual acceleration in the axial direction as well as energy for producing phosphor luminescence (26) when impacting this material.

33. “FLAT PANEL DISPLAYS ARRANGEMENT” in accordance with claim 1, characterized by the fact of said first (13) and second (15) conductive layers be formed by parallel tracks isolated among each other, forming two sets of tracks angularly disposed.

34. “FLAT PANEL DISPLAYS ARRANGEMENT” in accordance with claim 33, characterized by the fact of being said tracks disposed in a substantially orthogonal way.

35. “FLAT PANEL DISPLAYS ARRANGEMENT” in accordance with claims 10, 11, 12, 13, 14, 15, 16 or 17, characterized by the fact that said trespassing prismatic holes are integrally filled with a solid material that permits the free traffic of electrons.

36. “FLAT PANEL DISPLAYS ARRANGEMENT” in accordance with claim 33, characterized by the fact of being said material the DLC or an equivalent
